(19) United States
(12) Patent Application Publication
(10) Pub. No.: US 2008/0226109 A1
(43) Pub. Date: Sep. 18, 2008

(54) ACOUSTIC VIBRATION REPRODUCING APPARATUS

(76) Inventors: Yoko YAMAKATA, Tokyo (JP); Michiaki Katsumoto, Tokyo (JP)

Correspondence Address: NIXON & VANDERHYE, PC, 901 NORTH GLEBE ROAD, 11TH FLOOR, ARLINGTON, VA, 22203, US

(21) Appl. No.: 12/038,917

(22) Filed: Feb. 28, 2008

(30) Foreign Application Priority Data
Feb. 28, 2007 (JP) P2007-050751

(51) Int. Cl. H04R 1/20

(52) U.S. Cl. 381/339

(57) ABSTRACT

An acoustic vibration reproducing apparatus includes: a first vibration plate; a first exciting unit applying a vibration to the first vibration plate; and a second exciting unit applying, to the first vibration plate, a vibration different from the vibration applied by the first exciting unit.

### CROSS-REFERENCE TO RELATED APPLICATIONS

This application is based upon and claims the benefit of priority from the prior Japanese Patent Application No. 2007-050751, filed on Feb. 28, 2007; the entire contents of which are incorporated herein by reference.

### BACKGROUND OF THE INVENTION

1. FIELD OF THE INVENTION

The present invention relates to an acoustic vibration reproducing apparatus reproducing an acoustic vibration.

2. DESCRIPTION OF THE RELATED ART

Various techniques for reproducing sound have been developed. For example, there has been made public a technique relating to a panel speaker in which a flat plate-shaped vibration plate is driven by a driver (see JP-A 2005-117217 (KOKAI)). Further available is a technique to excite a liquid crystal display from two right and left points to vibrate the liquid crystal display, thereby generating a high-energy acoustic wave. Further, there is a technique relating to a stereophonic system, such as a stereo system and a trans-aural system, for enabling the perception of the (center) position of a musical instrument (sound image).

### BRIEF SUMMARY OF THE INVENTION

A sounding body such as, for example, a musical instrument produces sound by the vibration of its surface. At this time, many sounding bodies each have a certain degree of size rather than being a point, and different vibrations (vibrations different in at least one of frequency, amplitude, and phase) are continuously mixed on the surface of the sounding body. As a result, an acoustic wave generated from the sounding body reflects a three-dimensional structure of the sounding body and accordingly has a complicated waveform with its frequency, phase, or amplitude changing in a surface direction. Further, as is pointed out with respect to an effect (feeling of presence) of binaural recording, a human being hears, as sound, not only an acoustic wave directly reaching his/her ears but also an interference ascribable to an acoustic wave diffracted and reflected by various parts of his/her body (for example, head). From the above, it is thought that reproducing sound as a surface sound source can realize a higher feeling of presence than reproducing sound as a point sound source.

In view of the above, it is an object of the present invention to provide an acoustic vibration reproducing apparatus capable of reproducing an acoustic vibration including different coupled vibrations.

An acoustic vibration reproducing apparatus according to one aspect of the present invention includes: a first vibration plate; a first exciting unit applying a vibration to the first vibration plate; and a second exciting unit applying, to the first vibration plate, a vibration different from the vibration applied by the first exciting unit.

### BRIEF DESCRIPTION OF THE DRAWINGS

FIG. 1 is a schematic view showing an acoustic vibration reproducing apparatus according to a first embodiment of the present invention.

FIG. 2 is a cross-sectional view showing the internal structure of an acoustic vibration part according to the first embodiment.

FIG. 3 is a chart showing an example of a table in an excited point control table.

FIG. 4 is a chart showing an example of a table in the excited point control table.

FIG. 5 is a table showing a correspondence relation between fundamental frequencies f0 and vibration modes of a top of a violin.

FIG. 6 is a schematic view showing the vibration modes that the top and a back of the violin have.

FIG. 7A to FIG. 7F are schematic views showing results of simulations of a vibration state of a vibration plate.

FIG. 8 is a perspective view showing an acoustic vibration reproducing apparatus according to a second embodiment of the present invention.

FIG. 9 is a cross-sectional view showing the internal structure of an acoustic vibration part according to the second embodiment.

FIG. 10 is a schematic view showing an acoustic vibration reproducing apparatus according to a third embodiment of the present invention.

FIG. 11 is a cross-sectional view showing the internal structure of an acoustic vibration part according to the third embodiment.

FIG. 12 is a perspective view showing an acoustic vibration part according to a fourth embodiment.

FIG. 13 is a cross-sectional view showing the acoustic vibration part according to the fourth embodiment.

FIG. 14 is a view showing a correspondence relation between faces of a vibrating part and a stationary part.

FIG. 15 is a schematic view showing an acoustic vibration reproducing apparatus according to a fifth embodiment of the present invention.

FIG. 16 is a cross-sectional view showing the internal structure of an acoustic vibration part according to the fifth embodiment.

FIG. 17 is a schematic view showing an acoustic vibration reproducing apparatus according to a sixth embodiment of the present invention.

FIG. 18 is a cross-sectional view showing the internal structure of an acoustic vibration part according to the sixth embodiment.

### BRIEF DESCRIPTION OF THE INVENTION

Hereinafter, embodiments of the present invention will be described in detail with reference to the drawings.

### First Embodiment

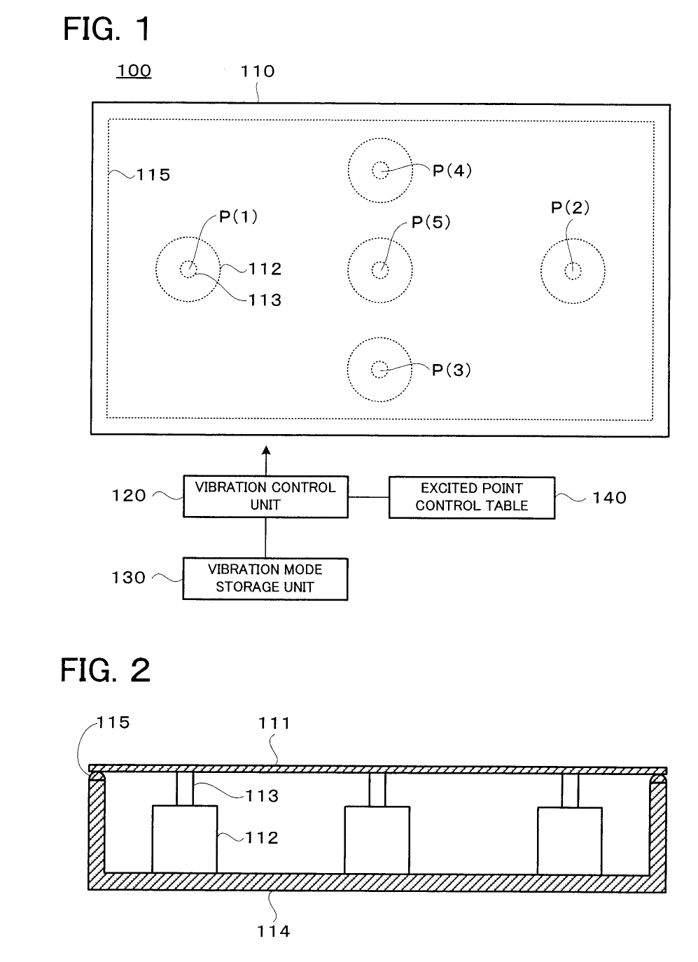

FIG. 1 is a schematic view showing an acoustic vibration reproducing apparatus 100 according to a first embodiment of the present invention. FIG. 2 is a cross-sectional view showing the internal structure of an acoustic vibration part 110 of the acoustic vibration reproducing apparatus 100. The acoustic vibration reproducing apparatus 100 has the acoustic vibration part 110, a vibration control unit 120, a vibration mode storage unit 130, and an excited point control table 140.

The acoustic vibration part 110 converts a signal output from the vibration control unit 120 into a vibration, and has a vibration plate 111, five exciting units 112, five vibration transmitting parts 113, an enclosure 114, and a sealing part 115.

The vibration plate 111 vibrates when vibrations are applied to excited points P(1) to P(5) by the exciting units 112. At this time, if at least one of the vibrations applied to the excited points P(1) to P(5) is different from the others, a plurality of different vibrations are applied to the vibration plate 111. “Different vibrations” refers to vibrations different in at least one of frequency, amplitude, and phase.

By the plural different vibrations being applied to the vibration plate 111, wavefronts made by the plural smoothly coupled acoustic vibrations are formed on a front surface of the vibration plate 111. At this time, nodes and antinodes of the vibrations are distributed on the vibration plate 111. This distribution can be considered as a vibration mode of the vibration plate 111. Specifically, the vibration mode and the distribution of the nodes and antinodes of the vibrations on the vibration plate 111 are in a correspondence relation. As will be described later, the vibration plate 111 can be vibrated in, for example, vibration modes A0, C1 to C4, and T1.

A vibration mode occurs when the vibrations applied to the excited points P(1) to P(5) by the exciting units 112 travel in the vibration plate 111 to be superimposed on one another on the vibration plate 111. Therefore, the vibration mode is not determined only by the vibrations applied to the excited points P(1) to P(5) (frequency ratio, amplitude ratio, phase difference) but depends on the shape, size, thickness, vibration transmission property, restriction conditions (for example, whether an end portion of the vibration plate 111 is fixed or free), and the like of the vibration plate 111.

The excited points P(1) to P(5) are appropriately disposed on the vibration plate 111. The excited points P(1) to P(5) are disposed so that a desired vibration mode is effectively generated. For example, if a desired vibration mode to be reproduced is a vibration mode of the top of a violin, it is effective to dispose the excited points on antinodes of the vibration of the top of the violin. Positions of the antinodes generally differ depending on a vibration mode, and therefore, a possible way to reproduce a plurality vibration modes is to dispose the excited points P at all the positions of the antinodes in all the vibration modes. However, since the antinodes of the vibration can be set at positions other than the excited points P, the excited points need not be disposed at the positions of the antinodes of the vibration.

The vibration plate 111 is a quadrangular (here, rectangular) flat plate. The rectangular shape is adopted because the rectangular shape can generate various vibration modes more easily than a square shape. A rectangle is more asymmetric than a square. A highly symmetric shape tends to produce less diversified vibration modes. Incidentally, the external shape of the vibration plate 111 may be an arc shape such as a circular shape or an elliptical shape, or may be any other shape. Further, a surface of the vibration plate 111 may be a curved surface instead of a planar surface (flat plate).

As a material of the vibration plate 111, usable are various materials such as wood (solid lumber, plywood (lauan plywood), MDF (Medium Density Firberboard, a plate made of wood fibers consolidated with an adhesive)), glass, metal, and a resin material (acryl or the like).

In consideration of reproducing tone of the violin by the vibration plate 111, it is conceivable that the vibration plate 111 is formed to have substantially the same size and is made of the same material as those of the top of the violin (for example, size: 200 mm×360 mm×3 mm, material: wood). The top of the violin has a thickness less than 3 mm, but is varnished to have increased rigidity. Considering this, if wood is used as it is as the material, its thickness is preferably about 3 mm. If a varnished wood or glass plate is used as the vibration plate 111, the thickness of the vibration plate 111 is smaller.

The five exciting units 112 are exciting devices (a kind of drivers) capable of independently applying vibrations to the respective five excited points P(1) to P(5) on the vibration plate 111. So-called vibrators also function as the exciting units 112. The exciting units 112 apply the vibrations to the excited points P(1) to P(5) of the vibration plate 111 by, for example, magnetic means such as voice coils or electric means such as piezoelectric elements. As the exciting units 112, usable is a vibrating device for speakers (for example, GY-1) manufactured by FOSTEX. Here, the vibrations are applied in a vertical direction of the surface of the vibration plate 111. The vibrations can be also applied in an oblique direction of the vibration plate 111 instead of the vertical direction.

The five vibration transmitting parts 113 couple the five exciting units 112 and the excited points P(1) to P(5) respectively to transmit the vibrations from the exciting units 112 to the excited points P. The vibration transmitting parts 113, the vibration plate 111, and the exciting units 112 are fixed to one another by screwing, bonding, or the like. An example of a usable material of the vibration transmitting parts 113 is a high-rigidity material such as a metal stick.

The enclosure 114 is intended for preventing a sound pressure generated on the front surface of the vibration plate 111 from being cancelled by a sound pressure generated on a rear surface thereof. When the vibration plate 111 vibrates, an air pressure difference occurs in a space adjacent to its front surface to generate an acoustic wave. At this time, near the rear surface of the vibration plate 111, an air pressure difference in opposite phase to that on the front surface occurs. Therefore, if air near the rear surface can freely move to the vicinity of the front surface, the air pressure differences are cancelled by each other. Specifically, the inside of the enclosure 114 is tightly closed and the acoustic wave from the rear surface of the vibration plate 111 stays in the enclosure 114 (interception of the acoustic wave). The enclosure 114 has a bottom plate and four side plates, and on its open top, the vibration plate 111 is disposed.

The sealing part (gasket) 115 is disposed around a gap near outer peripheries (end portions (edges, corners, or the like)) of the enclosure 114 and the vibration plate 111 (is disposed in a ring form) and it seals the enclosure 114 to restrict the flow of the acoustic waves out of the enclosure 114.

The sealing part 115 is made of a highly flexible material (with a small Young's modulus), for example, rubber so as not to restrict the vibration of the vibration plate 111 at the outer periphery. This allows the outer periphery of the vibration plate 111 to be a so-called free end. On the other hand, if the outer periphery of the vibration plate 111 is formed as a so-called fixed end, a high-rigidity material (with a large Young's modulus) is used. It can be appropriately decided whether to form the outer periphery of the vibration plate 111 as a free end or a fixed end. However, in general, forming the outer periphery of the vibration plate 111 as the free end can more increase diversity of the vibration modes that the vibration plate 111 can have. A node of the vibration falls on the outer periphery of the vibration plate 111 formed as a fixed end. On the other hand, both a node and an antinode of the vibration can fall on the outer periphery of the vibration plate 111 formed as a free end.

The flexibility/rigidity of the sealing part 115 greatly depends on its shape as well as the Young' s modulus of its constituent material. Here, the sealing part 115 has a semicircular cross section, tapering toward the vibration plate 111. As a result, a practical width of the sealing part 115 becomes smaller, which renders the vibration plate 111 a greater degree of freedom. For example, if the sealing part 115 has a quadrangular cross section, the degree of freedom of the vibration plate 111 depends on its width. Decreasing the width of the sealing part 115 results in a higher degree of freedom of the vibration of the vibration plate 111, but on the other hand, results in a lowered strength of the sealing part 115. By changing the width of the sealing part 115 in its height direction, it is possible to ensure both the degree of freedom of the vibration plate 111 and the strength of the sealing part 115.

Here, a material having vibration absorbency (synonymous with sound absorbency since acoustic vibration is an issue here) is used for the sealing part 115. As a result, the reflection of the vibration from the outer periphery (end portion) of the vibration plate 111 is restricted, enabling easier control of the vibration of the vibration plate 111. If the vibration is reflected from the outer periphery of the vibration plate 111, this reflected wave conflicts with the vibrations applied to the excited points P, which may make it difficult to control the vibration of the vibration plate 111. On the other hand, however, the use of a sound absorbing material for the sealing part 115 results in an energy loss of the applied vibrations. Therefore, in order to reduce the energy loss of the vibrations, it is also conceivable to use a material with low vibration absorbency for the sealing part 115.

An example of the vibration absorbing material is a porous material such as urethane rubber. When an acoustic vibration enters and diffuses in the porous material, the energy of the vibration is transformed into heat energy, resulting in a small reflected wave.

The vibration control unit 120 controls the vibrations applied by the exciting units 112(1) to 112(5) (frequencies, amplitudes, phases) independently. Sound generated by the vibration of the vibration plate 111 is defined in terms of a reference vibration (displacement from a reference point at time t) Ws(t) and a vibration mode M(t). The reference vibration Ws(t) determines basic elements of acoustic vibration (tone and intensity of sound) generated by the vibration plate 111 at the time t. Further, the vibration mode M (t) is equivalent to spatial distribution of the acoustic vibration (sound field) generated by the vibration plate 111 at the time t.

As the reference vibration Ws(t), an acoustic vibration W(t) desired to be reproduced, for example, a recorded waveform of performance of the violin is usable. However, what is recorded when the violin is played is sound and not the vibration itself of the top of the violin, and therefore, the acoustic vibration W(t) needs to be multiplied by an appropriate coefficient for the adjustment of an absolute value of the displacement of the vibration plate 111. By vibrating one of the excited points P (reference excited point Ps) with this reference vibration Ws(t), it is possible to reproduce the acoustic vibration W(t).

The vibration mode of the vibration plate 111 is determined by relative vibrations (frequency ratio, amplitude ratio, phase difference) at the excited points P(1) to P(5). The “frequency ratio” can be defined as a ratio of the frequency at each of the other excited points to the frequency at the reference excited point Ps. The “amplitude ratio” can be defined as a ratio of the amplitude at each of the other excited points to the amplitude at the reference excited point Ps. The “phase difference” can be defined as a relative phase at each of the other excited points P to the phase at the reference excited point Ps.

The vibration mode storage unit 130 stores the reference vibration Ws(t) and the vibration mode M(t) in correspondence to time (time shift of the vibration state). That is, the vibration mode storage unit 130 functions as a first storage unit storing a first table showing the vibration mode of the vibration plate 111 and time in correspondence to each other. Figuratively speaking in terms of musical instrument performance, the vibration mode storage unit 130 stores a score.

The excited point control table 140 stores, as a table, a relation between the vibration modes of the vibration plate 111 and relative vibrations of the exciting units 112. The excited point control table 140 functions as a second storage unit storing a second table showing the vibration modes of the vibration plate 111 in correspondence to at least one of a frequency ratio, an amplitude ratio, and a phase difference of each of the vibrations applied by the exciting units 112.

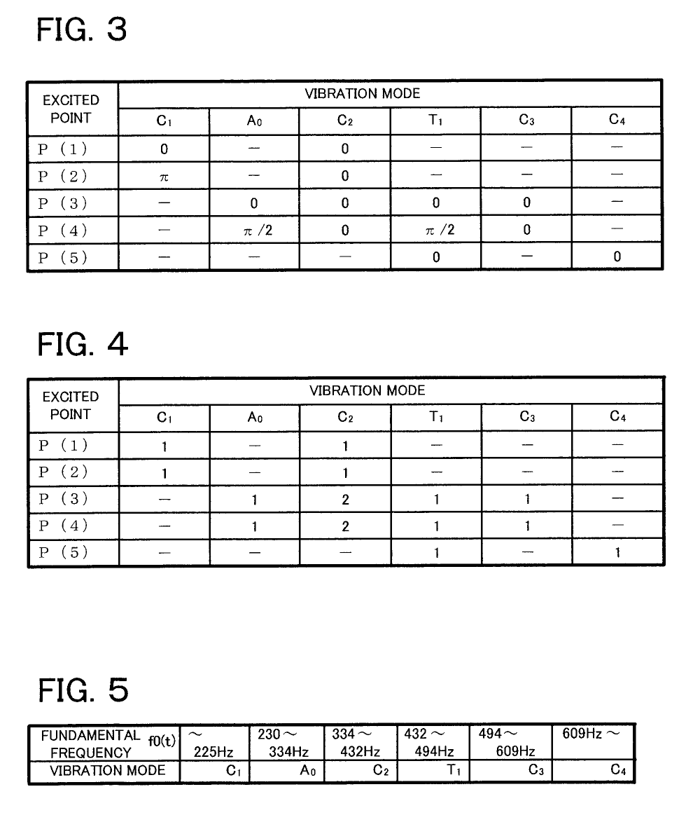

FIG. 3 and FIG. 4 are charts showing an example of tables in the excited point control table 140, the phase differences and the frequency ratios being separately shown in the respective tables in correspondence to the vibration modes. These tables correspond to the vibration modes of the top of the violin. That is, FIG. 3 and FIG. 4 show the phase differences and the amplitude ratios corresponding to the vibration modes A0, C1 to C4, and T1 that the top of the violin has. In this example, it is assumed that the vibrations applied to the excited points P(1) to P(5) have the same amplitude, but by making these amplitudes different, it is possible to generate more diversified vibration modes.

It should be noted that the phase differences and the frequency ratios maybe shown in one table though shown in the different tables here.

### (Operation of the Acoustic Vibration Reproducing Apparatus 100)

Hereinafter, the operation of the acoustic vibration reproducing apparatus 100 will be described. Here, the reproduction of an acoustic vibration from a musical instrument, in particular, from a top of a violin will be taken as an example. Here, a vibration of a back of the violin will be disregarded though its vibration state is not always the same as a vibration state of the top.

### A. Decision of a Vibration State to be Reproduced by the Acoustic Vibration Reproducing Apparatus 100

A vibration state to be reproduced by the acoustic vibration reproducing apparatus 100 is decided. This vibration state is defined in terms of the reference vibration Ws(t) and the vibration mode M(t).

The vibration mode to be reproduced can be decided by using the following methods (1), (2), for instance.

(1) Method 1: Measure the vibration mode M(t) of a reproduction target (here, a violin)

Music is played with the violin, and a vibration state of the top of the violin at this time can be measured by holographic interferometry, for instance. In the holographic interferometry, by using a hologram, wavefronts of reflected lights from the reproduction target before and after the reproduction target is deformed are interfered with each other and interference fringes showing the distribution of the deformation are generated. As a result, the deformation (vibration) of the top of the violin can be measured with high sensitivity.

(2) Method 2: Estimate the vibration mode M(t) from fundamental frequency f0(t)

A relation between the fundamental frequency and the vibration mode when the violin is played is known. Therefore, the vibration mode can be decided based on the fundamental frequency in the following procedure, for instance.

<a. Obtain the Acoustic Vibration W(t)>

Performance sound of the violin is recorded and the acoustic vibration W(t) is obtained. This acoustic vibration W(t) is multiplied by a predetermined coefficient, thereby defining the reference vibration Ws(t).

<b. Extract the Fundamental Frequency (Also Called a Tonic) f0(t)>

The fundamental frequency f0(t) is extracted from the obtained acoustic vibration W(t). The fundamental frequency f0(t) means a frequency having the greatest influence on an acoustic sense of a human being, that is, a frequency that is recognized as being “fundamental” among frequency components of sound.

For example, the acoustic vibration W(t) is subjected to frequency resolution and the result is shown as a spectrogram F(t), and the fundamental frequency f0(t) at the time (t) is specified. For the frequency resolution, FFT (Fast Fourier Transform)) is usable.

Normally, the lowest frequency with the largest sound pressure in the spectrogram F(t) is the fundamental frequency f0(t). However, at an instant when a string of the violin is played, even if the vibration has only a component of the fundamental frequency f0(t), there is a possibility that the obtained acoustic vibration W(t) may have a frequency component other than the fundamental frequency f0(t) (in particular, a harmonic). This is because a body of the violin resonates due to the vibration, so that a harmonic component or the like is amplified. Therefore, it is conceivable to use various methods such as cepstrum. In the cepstrum, the spectrogram F(t) of the acoustic vibration W(t) is transformed into a logarithm, which in turn is inversely fast-Fourier transformed.

<c. Estimate the Vibration Mode M(t)>

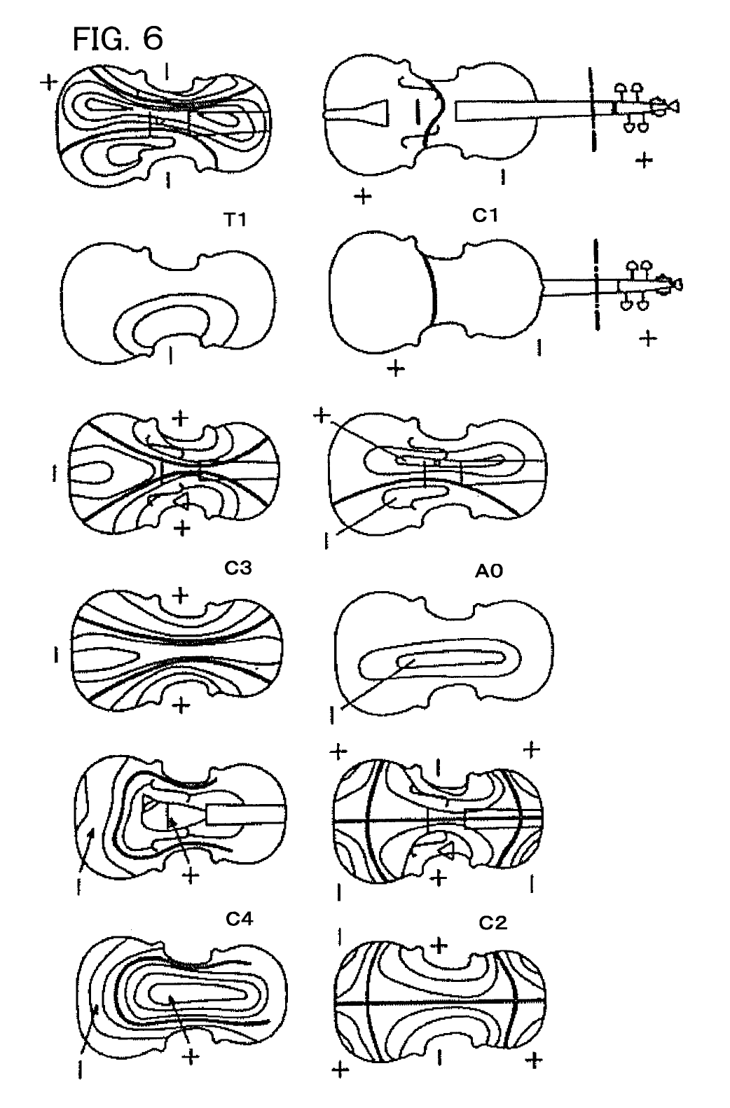

As for a violin, a relation between the fundamental frequency f0(t) and the vibration mode M(t) is known. FIG. 5 is a table showing a correspondence relation between the fundamental frequency f0 and the vibration mode of the top of the violin. As shown in FIG. 5, the top of the violin takes the vibration modes A0, C1 to C4, and T1 depending on the fundamental frequency f0(t). FIG. 6 is a schematic view showing the vibration modes A0, C1 to C4, and T1 that the top and the back of the violin have.

As described above, it is possible to estimate the vibration mode M(t) of, for example, the violin from the extracted acoustic vibration of the violin when it is played.

### B. Reproduction of Acoustic Vibration

### (1) Decide Vibrations to be Applied to the Excited Points P(1) to P(5)

A set of the reference vibration Ws(t) and the vibration mode M(t) is sequentially output from the vibration mode storage unit 130 to the vibration control unit 120, and the vibrations to be applied to the excited points P(1) to P( 5) are decided with reference to the excited point control table 140. The vibration mode of the vibration plate 111 changes depending on the phase difference or the amplitude ratio of the vibrations applied to the excited points P(1) to P(5). As previously described, the phase differences and the amplitude ratios corresponding to the vibration modes A0, C1 to C4, T1 that the top of the violin has are shown in FIG. 3 and FIG. 4.

Here, the acoustic vibration reproducing apparatus 100 stores both the reference vibration Ws(t) and the vibration mode M(t). However, the acoustic vibration reproducing apparatus 100 may store only the reference vibration Ws(t) and may automatically estimate the vibration mode M(t) from the reference vibration Ws (t). In this case, the acoustic vibration reproducing apparatus 100 extracts the fundamental frequency f0(t) from the reference vibration Ws(t) and estimates the vibration mode M(t) by using the table or the like showing the correspondence relation between the reference frequency f0 and the vibration mode M.

### (2) Apply the Vibrations to the Excited Points P(1) to P(5)

Controlled by the vibration control unit 120, the exciting units 112 apply the vibrations to the excited points P(1) to P(5) to acoustically vibrate the vibration plate 111.

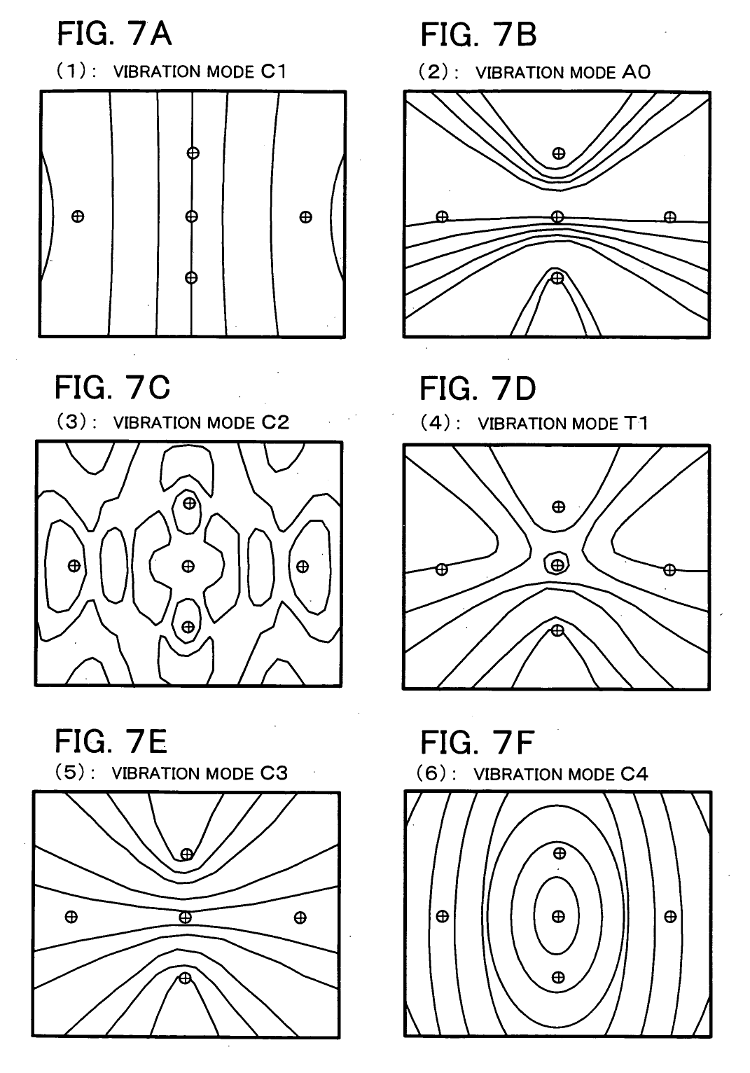

FIG. 7A to FIG. 7F are schematic views showing the results of simulations of the vibration state of the vibration plate 111. In the drawings, positions shown by circled “+” correspond to the excited points P(1) to P(5). FIG. 7A to FIG. 7F correspond to the vibration modes C1, A0, C2, T1, C3, C4 of the top of the violin which are shown in FIG. 6. In this manner, the vibrations corresponding to the vibration modes of the top of the violin can be generated on the vibration plate 111. That is, it is possible to reproduce the distribution of acoustic waves along the surface of the top of the violin (shape information).

In these simulations, the reflection of waves at edges (end portions) of the vibration plate 111 is disregarded and only primary propagation waves from the excited points P are handled. The waves reflected from the edges of the vibration plate 111 can be thought to be small compared with the primary propagation waves transmitted directly from the excited points P.

As described above, by applying the vibrations to the plural excited points P of the vibration plate 111, wavefronts made by the plural smoothly coupled vibrations can be generated on the front surface of the vibration plate 111. For example, as shown in the vibration mode C3 in FIG. 4, the vibrations including the fundamental frequency f0(t) and its harmonics are applied to the different excited points P and the vibrations are synthesized on the surface of the vibration plate 111. As a result, it is possible to generate acoustic waves having a wavelength change in the surface direction, which enables the expression of rich tones. At this time, the vibration plate 111 curves and sound is emitted along the curved surface.

A “speaker array” system is a possible method of forming the wavefronts made by a plurality of smoothly coupled vibrations as described above. In the “speaker array” system, a large number of typical loud speakers are disposed planarly and are controlled independently. In this system, however, the individual speaker can generate only single sound and occupies some space, which makes it difficult to ensure smooth coupling of waves generated by the speakers.

The acoustic vibration reproducing apparatus 100 does not directly reproduce a sound image, but reproduces the vibration and the shape of the surface of a sounding body (for example, a musical instrument) to synthesize the generated wavefronts. As a result, the smoothness of the wavefronts of acoustic vibrations generated from the vibration plate 111 can be easily ensured. The following second to fourth embodiments can provide the same advantages.

### Second Embodiment

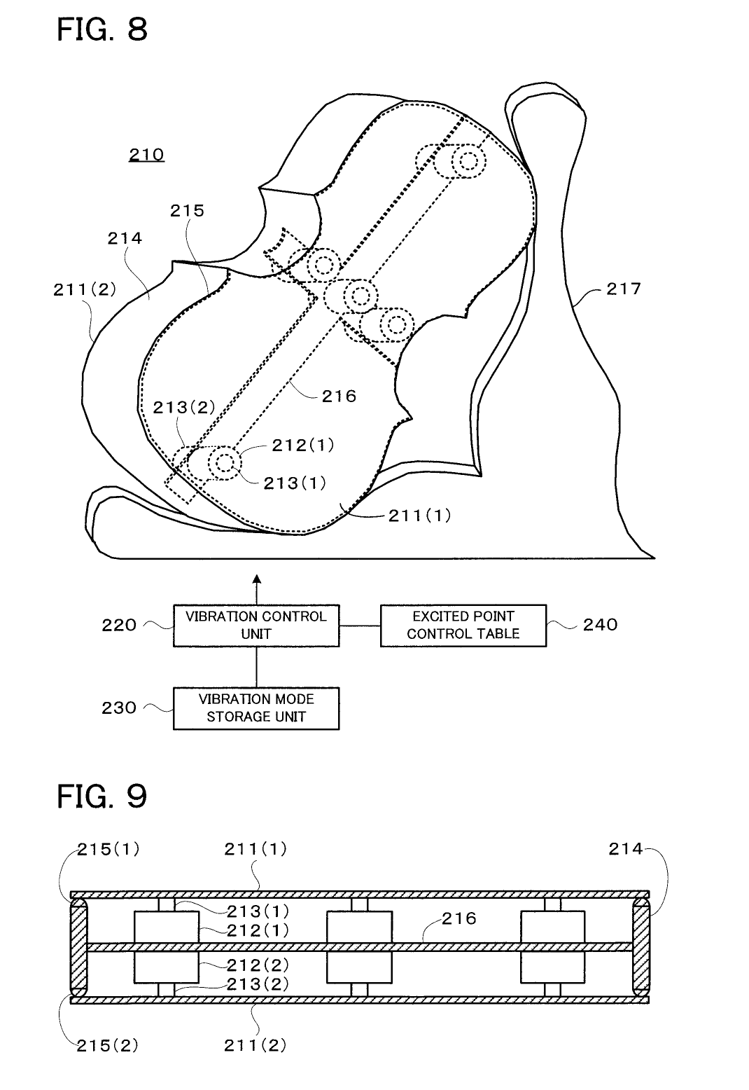

The second embodiment of the present invention will be described. FIG. 8 is a perspective view showing an acoustic vibration reproducing apparatus 200 according to the second embodiment of the present invention. FIG. 9 is a cross-sectional view showing the internal structure of an acoustic vibration part 210 of the acoustic vibration reproducing apparatus 200 of the present invention. The acoustic vibration reproducing apparatus 200 has the acoustic vibration part 210, a vibration control unit 220, a vibration mode storage unit 230, and an excited point control table 240.

The whole acoustic vibration part 210 has the shape of a violin and is capable of generating a vibration in a vibration mode closer to the original vibration mode of the violin. The acoustic vibration part 210 has vibration plates 211(1), 211(2), exciting units 212(1), 212(2), vibration transmitting parts 213(1), 213(2), an enclosure 214, sealing parts 215(1), 215(2), and a brace 216 and is supported on a holder 217.

The vibration plates 211(1), 211(2) have shapes (external shapes, dimensions, curved surfaces) corresponding to a top and a back of a violin respectively. Vibrations of both the top and the back of the violin, that is, a sound field generated from the violin can be faithfully reproduced.

The exciting units 212(1), 212(2) vibrate the vibration plates 211(1), 211(2) respectively and are disposed on both surfaces of the brace 216.

The enclosure 214 has a shape corresponding to a side panel of the violin, and the vibration plates 211(1), 211(2) which are attached to the enclosure 214 as its top plate and bottom plate seal the inside of the enclosure 214 to prevent the vibrations from being emitted out of the enclosure 214.

The sealing parts 215(1), 215(2) are disposed for the vibration plates 211(1), 211(2) respectively to extend along upper and lower edges of the enclosure 214 and restrict the flow of acoustic waves out of the enclosure 214.

The brace 216 is a plate having a shape of a cross and its four ends are fixed to the enclosure 214. The exciting units 212(1), 212(2) are disposed on an upper and a lower surface of the brace 216 to independently control the vibration plates 211(1), 211(2) respectively, thereby enabling faithful reproduction of the vibrations of the top and the back of the violin. That is, the brace 216 functions as a stationary part on which the exciting units 212 are disposed. The brace 216 preferably has rigidity since it serves as a basis of the vibrations of the vibration plates 211(1), 211(2).

The vibration control unit 220 controls the two vibration plates 211(1), 211(2) independently via the exciting units 212(1), 212(2).

The vibration mode storage unit 230 stores a reference vibration Ws(t) and a vibration mode M(t) of the violin, for instance, in correspondence to time (time shift of a vibration state).

The excited point control table 240 stores, as a table, a relation between vibration modes of the vibration plates 211(1), 211(2) and relative vibrations of the exciting units 212(1), 212(2). The vibration states of the top and the back of the violin may be in the same vibration mode or may be in different vibration modes. Therefore, vibrations applied to the vibration plates 211(1), 211(2) are not completely the same.

### Third Embodiment

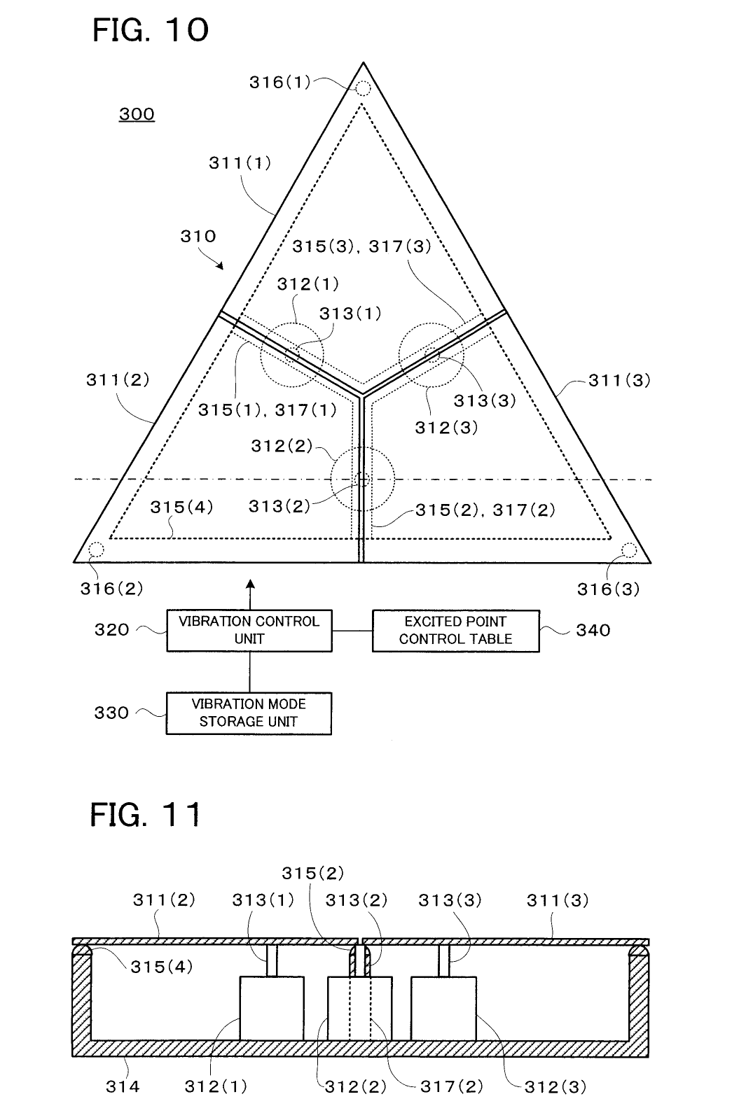

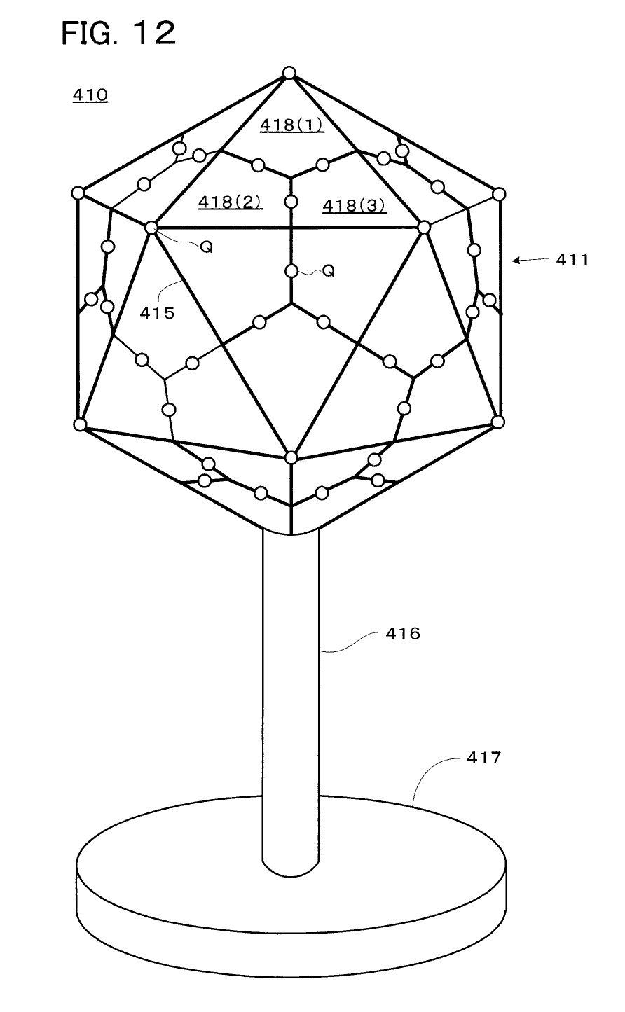

The third embodiment of the present invention will be described. FIG. 10 is a schematic view showing an acoustic vibration reproducing apparatus 300 according to the third embodiment of the present invention. FIG. 11 is a cross-sectional view showing the internal structure of an acoustic vibration part 310 of the acoustic vibration reproducing apparatus 300. The acoustic vibration reproducing apparatus 300 has the acoustic vibration part 310, a vibration control unit 320, a vibration mode storage unit 330, and an excited point control table 340.

The acoustic vibration part 310 has vibration plates 311(1) to 311(3), exciting units 312(1) to 312(3), vibration transmitting parts 313(1) to 313(3), an enclosure 314, sealing parts 315(1) to 315(4), fixing parts 316(1) to 316(3), and partition plates 317(1), 317(3).

The vibration plates 311(1) to 311(3) have a shape corresponding to parts into which a regular triangle is trisected with respect to its center and the whole assembly of the vibration plates 311(1) to 311(3) forms a substantially regular triangle. The vibration plates 311(1) to 311(3) vibrate while being coupled to one another via the sealing parts 315(1) to 315(3). An angular relation among the vibration plates 311(1) to 311(3) along the sealing parts 315(1) to 315(3) can be changed, thereby improving a degree of freedom of vibrations of the vibration plates 311(1) to 311(3) while keeping a continuous vibration state as a whole. For example, on borders (adjacent peripheral edges) of the vibration plates 311(1) to 311(3), vibrations continue and wavefronts of acoustic vibrations generated from the vibration plates 311(1) to 311(3) are coupled, so that continuous wavefronts are generated on front surfaces of the vibration plates 311(1) to 311(3).

The vibration plates 311(1) to 311(3) are fixed by the fixing parts 316(1) to 316(3) respectively, and vibrations are applied to each of the vibration plates 311(1) to 311(3) by two of the exciting units 312. For example, if the vibrations applied by the two exciting units 312 have no phase difference (are in the same phase), the vibration plate 311 bends upward and downward with the fixing part 316 as a fulcrum. Further, if the phase difference of the vibrations applied by the two exciting units 312 is 180°, the vibration plate 311 twists with respect to the fixing part 316. Combining the vibrations of the respective vibration plates 311(1) to 311(3) makes it possible to appropriately set the wavefronts of the vibration generated from the whole vibration plate 311.

The exciting units 312(1) to 312(3) are disposed at the positions overlapping with the borders (edges, end portions) of the vibration plates 311(1) to 311(3) respectively, each capable of simultaneously applying the vibration to two of the vibration plates 311. As a result, it is possible to ensure continuity of the vibrations on the vibration plates 311(1) to 311(3) and efficiently vibrate the vibration plates 311.

The enclosure 314 has a bottom plate and three side plates, and the movement of air (flow of acoustic waves) between the outside and inside of the enclosure 314 is intercepted so that waves generated from front surfaces of the vibration plates 311 are not cancelled by waves generated from rear surfaces thereof. The enclosure 314 is partitioned by the partition plates 317(1) to 317(3) to be divided into three spaces corresponding to the vibration plates 311(1) to 311(3) respectively. Sounds in the three spaces are intercepted by the partition plates 317(1) to 317(3), so that different acoustic spaces are formed. This is intended to reduce an influence that each of the vibrations of the respective vibration plates 311(1) to 311(3) has on the vibrations of the others, thereby ensuring easiness of control.

The sealing parts 315(1) to 315(3) are disposed on end surfaces of the partition plates 317(1) to 317(3) and end surfaces of the side plates of the enclosure 314 to seal gaps between the vibration plates 311(1) to 311(3) and the enclosure 314, thereby restricting the flow of the acoustic waves out of the enclosure 314.

The fixing parts 316(1) to 316(3) are fixing members fixing the respective vibration plates 311(1) to 311(3) to the enclosure 314, and are, for example, screws or adhesives. Here, the exciting units 312 may be disposed in place of the fixing parts 316(1) to 316(2), which can improve a degree of freedom of the vibrations of the vibration plates 311.

As described above, by applying the vibrations to the borders of the vibration plates 311(1) to 311(3) respectively, wavefronts made by the plural smoothly coupled vibrations can be generated on the front surfaces of the vibration plates 311(1) to 311(3). The whole assembly of the vibration plates 311(1) to 311(3) curves and sound is emitted along this curved surface.

### Fourth Embodiment

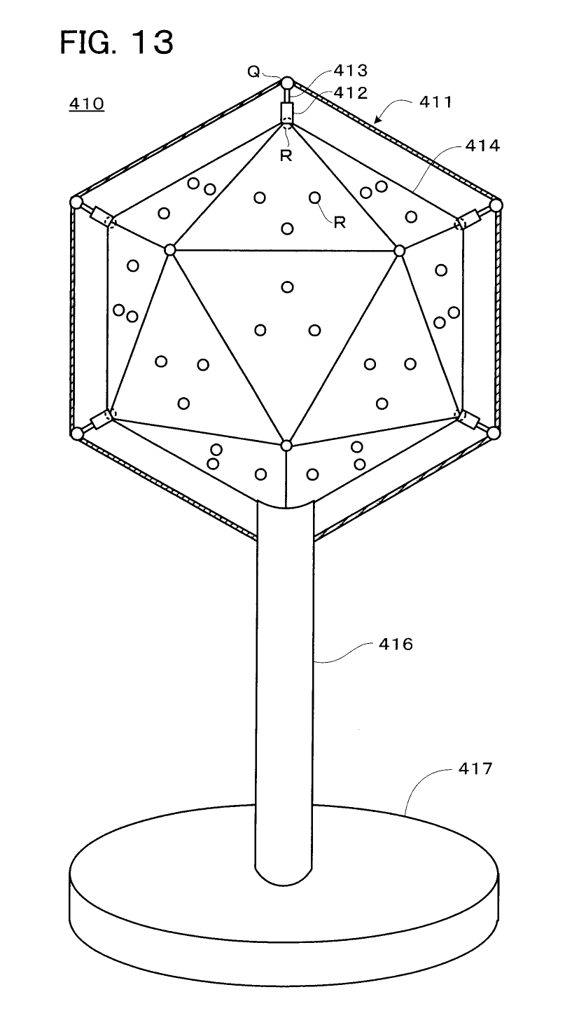

The fourth embodiment of the present invention will be described. FIG. 12 and FIG. 13 are a perspective view and a cross-sectional view showing an acoustic vibration part 410 of an acoustic vibration reproducing apparatus 400 according to the fourth embodiment of the present invention. The acoustic vibration part 410 has a vibrating part 411, exciting units 412, vibration transmitting parts 413, a stationary part 414, sealing parts 415, a brace 416, and a pedestal 417. In addition to the acoustic vibration part 410, the acoustic vibration reproducing apparatus 400 has a vibration control unit 420, a vibration mode storage unit 430, and an excited point control table 440, which are not shown.

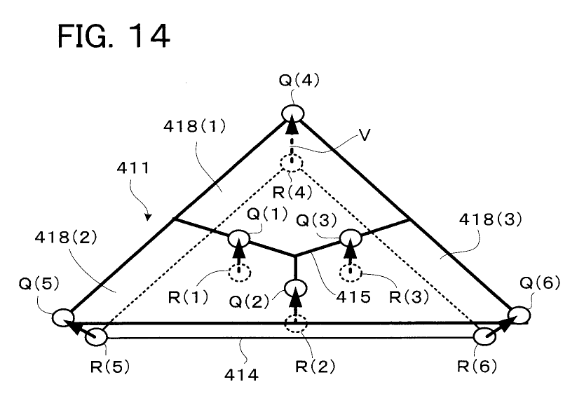

The external shapes of the vibrating part 411 and the stationary part 414 are similar to each other, each being an icosahedron having substantially regular triangular faces. FIG. 14 is a view showing a correspondence relation between the faces of the vibrating part 411 and the stationary part 414. The faces of the vibrating part 411 and the stationary part 414 are substantially parallel to each other. Three vibration plates 418(1) to 418(3) are disposed on each of the faces of the vibrating part 411. The three vibration plates 418(1) to 418(3) have shapes corresponding to those of the vibration plates 311(1) to 311(3) of the third embodiment, and vibrations V are applied to excited points Q(1) to Q(6) by the exciting units 412 through the vibration transmitting parts 413, the exciting units 412 and the vibration transmitting parts 413 being disposed at positions R(1) to R(6) of the stationary part 414 respectively. That is, unlike the third embodiment, the vibrations V can be applied to corners of the vibration plates 418 as well. For easier viewing of the drawing, some of the exciting units 412 and the vibration transmitting parts 413 are not shown.

The sealing parts 415 are disposed between the vibration plates 418. As a result, the flow of acoustic vibrations out of the vibrating part 411 (space between the vibrating part 414 and the stationary part 411) is prevented. An example usable as the sealing parts 415 is a flexible material such as rubber.

The stationary part 414 is fixed to the brace 416 and has the exciting units 412 thereon. The stationary part 414 is made of a vibration absorbing (sound insulating) material, so that the flow of the acoustic vibrations through the brace 416 is restricted.

As described above, by applying the vibrations to the borders of the plural (20×3 pieces) vibration plates 418 respectively, wavefronts made by the plural smoothly coupled vibrations can be generated around the vibrating part 411. Forming the vibrating part 411 in a substantially spherical shape (accurately, a polyhedral shape), it is possible to reproduce an acoustic vibration of any sounding body (for example, a musical instrument), with no limitation of its kind.

### Fifth Embodiment

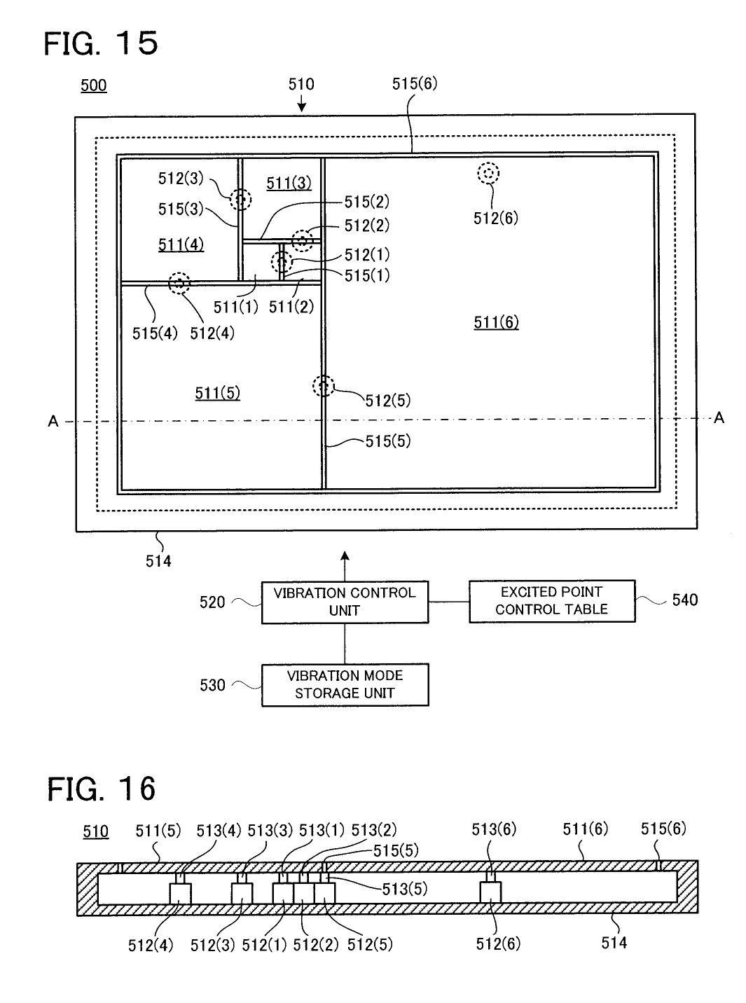

A fifth embodiment of the present invention will be described. FIG. 15 is a schematic view showing an acoustic vibration reproducing apparatus 500 according to the fifth embodiment of the present invention. FIG. 16 is a cross-sectional view showing the internal structure of an acoustic vibration part 510 of the acoustic vibration reproducing apparatus 500 taken along the A-A line in FIG. 15. The acoustic vibration reproducing apparatus 500 has the acoustic vibration part 510, a vibration control unit 520, a vibration mode storage unit 530, and an excited point control table 540.

The acoustic vibration part 510 has vibration plates 511(1) to 511(6), exciting units 512(1) to 512(6), vibration transmitting parts 513(1) to 513(6), an enclosure 514, and sealing parts 515(1) to 515(6).

Each of the vibration plates 511(1) to 511(6) has a square shape and the whole assembly thereof forms a rectangle. A length ratio of sides of the vibration plates 511(1) to 511(6) is 1:1:2:3:5:8, which is a Fibonacci sequence. The Fibonacci sequence is a sequence in which a numerical value of a term is equal to the sum of the previous two terms (Fₙ+Fₙ₊₁=Fₙ₊₂, F₁=F₂=1). The lengths of the sides of the vibration plates 511(1) to 511(6) are defined according to the Fibonacci sequence, so that the assembly (511(1) to 511(n)) of the first vibration plate 511(1) to the n-th (n: integer) vibration plate 511(n) can always form a rectangle.

The exciting units 512(1)to 512(5) are disposed at positions overlapping with borders (sides) of the vibration plates 511(1) to 511(6) respectively, each capable of applying a vibration simultaneously to two of the vibration plates 511. Further, the exciting unit 512(6) is disposed near a border between the vibration plate 511(6) and a top plate of the enclosure 514 so as to overlap with the vibration plate 511(6). Incidentally, the exciting unit 512(6) may be disposed at other position (for example, at a position overlapping with any of the vibration plates 511(1) to 511(5)).

The enclosure 514 has the top plate (having an opening), a bottom plate, and four side plates to intercept the movement of air (flow of an acoustic wave) out of the enclosure 514.

The sealing parts 515(1) to 515(5) seal the borders between the vibration plates 511(1)to 511(6). The sealing part 515(6) seals a gap between the vibration plates 511(1) to 511(6) and the enclosure 514. The sealing parts 515(1) to 515(6) restrict the flow of the acoustic waves out of the enclosure 514.

By applying the vibrations to the borders and so on of the vibration plates 511(1) to 511(6) respectively, wavefronts made by the plural smoothly coupled vibrations can be generated on front surfaces of the vibration plates 511(1) to 511(6).

Here, the vibration plates 511(2) to 511(6) are similar to one another (square) and lengths of their sides are different to one another. As a result, vibrations in a common vibration mode M and with different natural frequencies f can be induced on the vibration plates 511(2) to 511(6). On the vibration plates 511 similar to one another, the same vibration modes M (vibration modes in which the distributions of vibrations (distributions of nodes and antinodes of the vibrations) on the vibration plates 511 are similar to one another) can be induced. On the other hand, the natural frequency of each of the vibration plates 511 depends on the length of its side (the natural frequency of a square vibration plate 511 is inversely proportional to a square value of the length of its side). By inducing the common vibration modes with different natural frequencies, it is possible to accurately reproduce vibration including various frequencies.

On the other hand, it is also possible to vibrate the vibration plates 511(2) to 511(6) in different vibration modes M. The exciting units 512(2) to 512(5) are disposed at positions overlapping with the borders of the vibration plates 511(2) to 511(6), and amplitudes at the excited points corresponding to the exciting units 512(1) to 512(5) are equal. Nevertheless, the vibration modes of the vibration plates 511(2) to 511(6) can be made different.

As described above, by using the vibration plates 511(2) to 511(6) different in size, it is possible to secure diversity of the natural frequency or the vibration mode and accurately reproduce complicated vibrations.

The lengths of the sides of the vibration plates 511(2) to 511(6) are increased in this order and the vibration plates 511(2) to 511(6) are arranged in an anticlockwise spiral form. That is, the vibration plates 511 different in size are disposed in a well-balanced manner, so that the frequency distribution of acoustic waves generated in the upward/downward and rightward/leftward directions are kept well-balanced.

The vibration plate 511(1) is the same in size as the vibration plate 511(2), but can contribute to diversity of the natural frequency and the vibration mode if its excitation by the exciting unit 512 is controlled. However, the vibration plate 511(1) may be omitted. For example, the vibration plate 511(1) may be replaced by a stationary member fixed to the enclosure 514.

### Sixth Embodiment

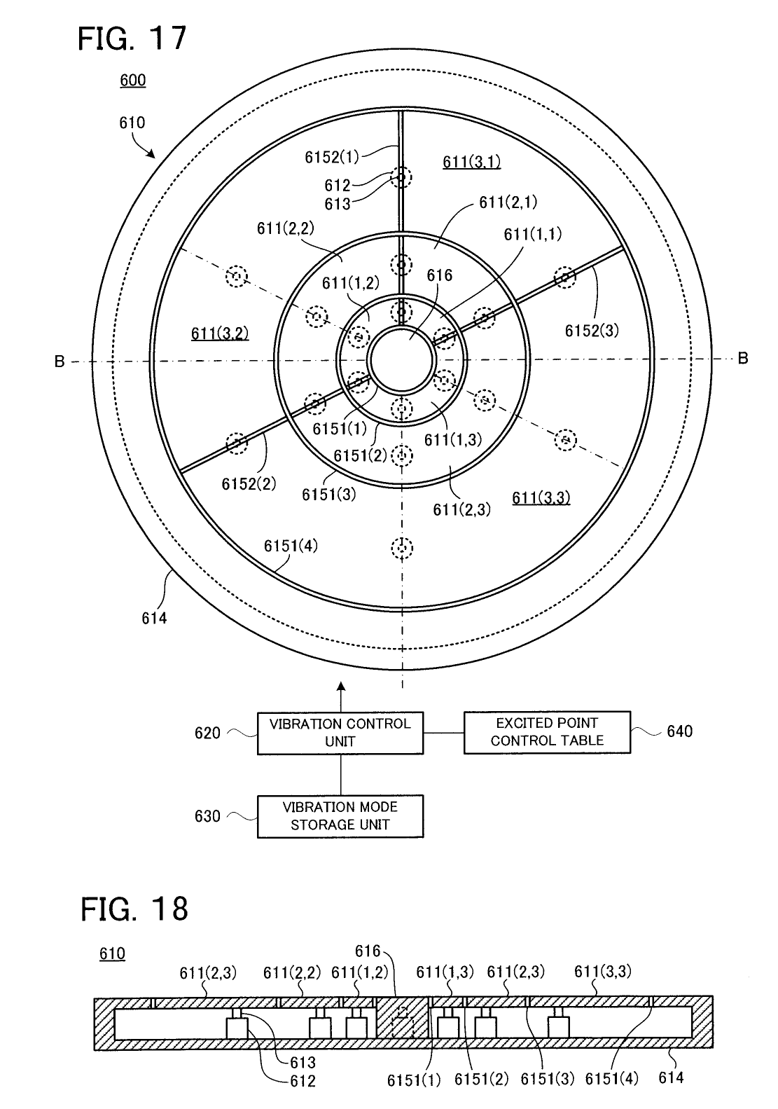

A sixth embodiment of the present invention will be described. FIG. 17 is a schematic view showing an acoustic vibration reproducing apparatus 600 according to the sixth embodiment of the present invention. FIG. 18 is a cross-sectional view showing the internal structure of an acoustic vibration part 610 of the acoustic vibration reproducing apparatus 600 taken along the B-B line in FIG. 17. The acoustic vibration reproducing apparatus 600 has the acoustic vibration part 610, a vibration control unit 620, a vibration mode storage unit 630, and an excited point control table 640.

The acoustic vibration part 610 has vibration plates 611(1, 1) to 611(3, 3), exciting units 612, vibration transmitting parts 613, an enclosure 614, sealing parts 615 (6151(1) to 6151(4), 6152(1) to 6152(3)), and a stationary part 616.

The whole assembly of the vibration plates 611(1, 1) to 611(3, 3) has a substantially circular shape and is divided into three sections in a diameter direction and into three sections in an argument direction. The vibration plates 611(1, 1) to 611(3, 3) are different in length in the diameter direction and in angle in the argument direction (here, a length ratio is 1:2:3 and an angle ratio is 1:2:3 (60°:120°:180°)). That is, each of the vibration plates 611(1, 1) to 611(3, 3) has a substantially fan shape. If each of the vibration plates 611(1, 1) to 611(3, 3) has a doughnut shape, vibration modes induced on the vibration plates 611(1, 1) to 611(3, 3), that is, reproduced vibrations are limited to simple ones. By dividing the vibration plate 611 in the argument direction, effective vibration modes can be induced on the vibration plates 611(1, 1) to 611(3, 3).

The vibration plates 611(1, j) to 611(3, j) (j: integer) arranged in the diameter direction are similar to one another and are different in area. As a result, vibrations in common vibration modes M and with different natural frequencies f can be induced on the vibration plates 611 arranged in the diameter direction. By inducing the vibrations in the common vibration modes and with different natural frequencies, it is possible to accurately reproduce vibrations including various natural frequencies. The natural frequencies of the vibration plates 611(1, j) to 611(3, j) decrease in this order.

The vibration plates 611(i, 1) to 611(i, 3) (i: integer) arranged in the argument direction are different in aspect ratio (a ratio of lengths in the diameter direction and the argument direction). As a result, vibration modes with different aspect ratios (vibration modes in which the aspect ratios of the distributions of vibrations (distributions of nodes and antinodes of the vibrations) on the vibration plates 611) are different) can be induced on the vibration plates 611 arranaged in the argument direction. By inducing various vibration modes, it is possible to accurately reproduce vibrations including various frequencies.

The exciting units 612 are disposed at positions overlapping with the vibration plates 611(1, 1) to 611(3, 3) and their borders (edges), each capable of applying a vibration simultaneously to two of the vibration plates 611. As a result, it is possible to ensure continuity of vibrations on the vibration plates 611(1, 1) to 611(3, 3) and efficiently vibrate the vibration plates 611(1, 1) to 611(3, 3).

The enclosure 614 has a top plate (having an opening), a bottom plate, and a side plate to intercept the movement of air (flow of acoustic waves) out of the enclosure 614. This is intended to reduce an influence that the vibration of each of the vibration plates 611(1, 1) to 611(3, 3) has on the other vibration plates 611, thereby ensuring easiness of control.

The sealing parts 615(6151(1) to 6151(4), 6152(1) to 6152(3)) seal the borders of the vibration plates 611(1, 1) to 611(3, 3), the enclosure 614, and the stationary part 616 to restrict the flow of the acoustic waves out of the enclosure 614. The sealing parts 6151(1) to 6151(4), 6152(1) to 6152(3) extend in the argument direction and the diameter direction respectively to seal the borders of the vibration plates 611(1, 1) to 611(3, 3), the enclosure 614, and the stationary part 616.

The stationary part 616 is fixed on the bottom plate of the enclosure 614.

### Other Embodiments

The above-described embodiments are not intended to restrict embodiments of the present invention but can be extended and modified, and extended and modified embodiments are also included in the technical scope of the present invention.

For example, in the first embodiment, the five exciting units apply the vibrations to the single vibration plate. The number of the exciting units may be appropriately set in a range of two or more. Increasing the number of the exciting units enables more diversified vibrations of the vibration plate. Instead of the shape of the violin in the second embodiment, a shape of another musical instrument, for example, a shape of a guitar or the like can be adopted. In the third and fourth embodiments, the three vibration plates are combined to form a surface. The number of the combined vibration plates may be one, two, or four or more. As the number of faces of the polyhedron in the fourth embodiment, other numbers, for example, 6, 8, and 12 can be adopted. Further, instead of the combination of the planar faces, the combination of spherical faces can be adopted.

In the fifth and sixth embodiments, the vibration plates 511, 611 are not fixed to the enclosures 514, 614 and thus can vibrate freely (a structure corresponding to the fixing parts 316 of the third embodiment is not provided). On the other hand, the vibration plates 511, 611 may be partly fixed so that the vibrations thereof are mechanically restricted.

What is claimed is:

1. An acoustic vibration reproducing apparatus, comprising:
a first vibration plate;
a first exciting unit applying a vibration to the first vibration plate; and
a second exciting unit applying, to the first vibration plate, a vibration different from the vibration applied by the first exciting unit.

2. The acoustic vibration reproducing apparatus according to claim 1, further comprising
a second vibration plate,
wherein the first exciting unit applies the vibration to the second vibration plate.

3. The acoustic vibration reproducing apparatus according to claim 2,
wherein the first and second vibration plates are different in area.

4. The acoustic vibration reproducing apparatus according to claim 2,
wherein the first and second vibration plates have a first and a second end portion disposed adjacent to each other; and
wherein the first exciting unit applies the vibration to vicinities of the first and second end portions.

5. The acoustic vibration reproducing apparatus according to claim 4, further comprising
a sealing part sealing a gap between the first and second end portions.

6. The acoustic vibration reproducing apparatus according to claim 1, further comprising
a stationary part having a surface on which the first and second exciting units are disposed.

7. The acoustic vibration reproducing apparatus according to claim 1, further comprising
one exciting unit or more applying, to the first vibration plate, a vibration different from at least one of the vibrations applied by the first and second exciting units.

8. The acoustic vibration reproducing apparatus according to claim 1,
wherein the first vibration plate has a shape closely resembling a shape of a sounding board of a musical instrument.

9. The acoustic vibration reproducing apparatus according to claim 1, further comprising:
a first storage unit storing a first table showing a vibration mode of the first vibration plate and time in correspondence to each other;
a second storage unit storing a second table showing the vibration mode of the first vibration plate in correspondence to at least one of a frequency ratio, an amplitude ratio, and a phase difference of the vibrations applied by the first and second exciting units; and
a control unit controlling the first and second exciting units based on the first and second tables.
